(19) United States
(12) Patent Application Publication
(10) Pub. No.: US 2006/0111608 A1
(43) Pub. Date: May 25, 2006

(54) Shower attachment having the appearance of a human structure and method therefor

(75) Inventor: Mark Vincent Kennedy, Las Vegas, NV (US)

Correspondence Address: WEISS & MOY PC, 4204 NORTH BROWN AVENUE, SCOTTSDALE, AZ, 85251, US

(73) Assignee: MARK VINCENT KENNEDY

(21) Appl. No.: 10/993,237

(22) Filed: Nov. 19, 2004

(51) Int. Cl. A61F 5/00; B05B 1/00

(52) U.S. Cl. 600/38; 4/615

(57) ABSTRACT

A shower attachment is configured to have the appearance of a human structure. In one embodiment, the human structure is a male penis, and the shower attachment in this embodiment has a shaft and a glans. Water enters the shower attachment and, preferably, exists through one or more openings in the glans and/or shaft.

### FIELD OF THE INVENTION

This invention relates generally to shower attachments and, more particularly, to a shower attachment having the appearance of a human structure, such as a male penis.

### BACKGROUND OF THE INVENTION

In the typical shower, water is emitted from a spray nozzle coupled to a pipe projecting from a shower wall, and positioned so as to be higher than the head of a typical shower user. In many showers, the substantially fixed location shower head is replaced with a shower head that is coupled to an elongated, flexible hose. This permits the user to achieve more focused washing action, by removing the shower head and positioning it in proximity to the portion of the body to which the user desires to give maximum attention.

In many European countries, and increasingly in the United States, greater attention is being provided to the unique hygienic needs of women. Bidets are thus provided for purposes of allowing women to achieve a more effective and direct cleansing of intimate areas.

There are a variety of known sexual aids that are based on the shape of the male penis. Commonly referred to as “dildos,” these come in a variety of styles. The outer surfaces are often styled to simulate the feel of a real male penis, and latex and gel have been used to achieve such an effect. Many dildos lack any means for providing movement, others have a vibrating capacity. A typical use of dildos is to simulate intercourse, whether vaginal or anal.

A need exists for a shower attachment that simulates a human appendage, including for example a male penis, and that may be used both for purposes of providing an especially effective cleaning action and that also serves as a sexual aid. The present invention provides this need, and other, related, advantages.

### SUMMARY OF THE INVENTION

In accordance with one embodiment of the present invention, a shower attachment is disclosed. The shower attachment, in this embodiment, comprises, in combination: a shower attachment having the appearance of a human structure; and means for coupling the shower attachment to a water source.

In accordance with another embodiment of the present invention, a shower attachment is disclosed. The shower attachment, in this embodiment, comprises, in combination: a shower attachment having the appearance of a human structure; wherein the human structure is a penis having a shaft and a glans; means for coupling the shower attachment to a water source; at least one opening in the glans; and a flexible hose coupled at a first end thereof to the shower attachment and at a second end thereof to a water source.

In accordance with a further embodiment of the present invention, a method for providing an enhanced shower experience is disclosed. The method, in this embodiment, comprises the steps of: providing a shower attachment having the appearance of a human structure; coupling the shower attachment to a water source; transmitting water from the water source through the shower attachment; bringing the shower attachment into contact with a body of a person using the shower attachment.

### BRIEF DESCRIPTION OF THE DRAWINGS

FIG. 1 is a perspective view of a shower attachment consistent with an embodiment of the present invention, prior to use.

FIG. 2 is a side view illustrating coupling of the shower attachment of FIG. 1 to a flexible hose.

FIG. 3 is an end view of a shower attachment consistent with an embodiment of the present invention.

FIG. 4 is an end view of a shower attachment consistent with an embodiment of the present invention.

FIG. 5 is a front view illustrating use of a shower attachment consistent with an embodiment of the present invention.

FIG. 6 is a perspective view of an embodiment of a shower attachment consistent with an embodiment of the present invention, including a soap dispensing feature.

### DETAILED DESCRIPTION OF THE PREFERRED EMBODIMENTS

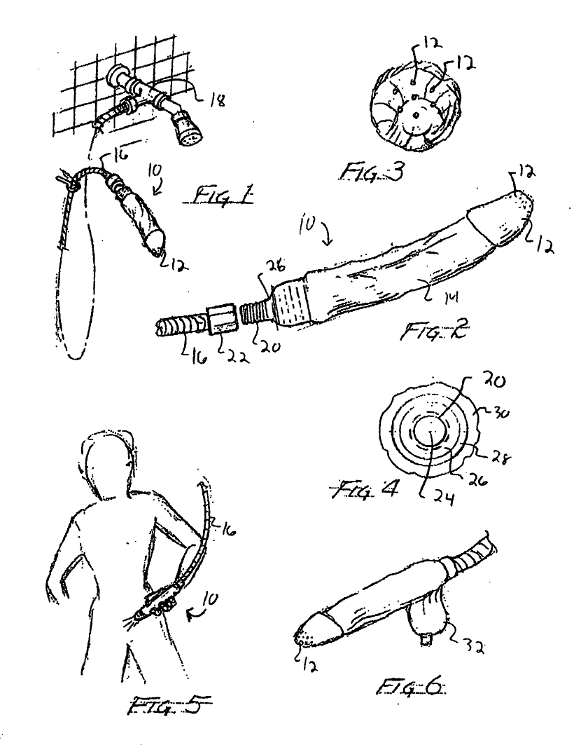

Referring initially to FIGS. 1, 2 and 5, the main features of a shower attachment 10 consistent with an embodiment of the present invention are illustrated. In this embodiment, the shower attachment 10 has the appearance of a male penis. In particular, it includes a glans 12 and a shaft 14. The attachment 10 may be coupled by any desired means to a first end of a flexible hose 16. The flexible hose 16 may be coupled, at a second end thereof, to a source of shower water 18. It should be clearly understood that the term “water”, as used in this application, includes all liquids that are substantially water-based, such as treated water, soft water, and even lubricants. It should be further understood that although in the preferred embodiment the flexible hose 16 is coupled to a source of shower water 18, it is within the spirit sand scope of this invention that the flexible hose 16 may be coupled to alternative liquid dispensing sources, such as an outdoor water spigot, a portable shower water source and the like.

Referring additionally to FIG. 3, in one embodiment, a plurality of openings 20 are provided in the glans 12. This permits, as shown in FIG. 5, water to exit via openings 20 from the glans 12.

It should be noted that it would be possible to vary the number of openings 20 as desired, from as few as one to a plurality. The varying of the number of openings 20 as well as the size thereof can affect the strength and focus of the water stream emitted therefrom. In turn, this can affect the quality of the cleaning action and/or the physical sensation provided by the attachment 10.

It may also be desired to provide one or more openings (not shown) along the shaft 14, in various numbers, sizes and positions as desired. Again, these openings can contribute to a different cleaning experience and/or physical sensation.

It may be desired to provide a set of attachments 10, each of which would be coupleable to a single flexible hose 16. The individual attachments 10 in such a set could be distinguished in any of a desired number of ways, such as with respect to the size of the shaft 14 and/or glans 12, the number or position of openings on the glans 12 and/or shaft 14, the materials used in the construction of the attachment 10, and so forth. (Alternatively, it may be desired to provide a plurality of different glans 12, each of which may be selectively coupled to the shaft 14, to provide variety in this fashion.) In this fashion, a user may vary the attachments 10 as desired, for example to use one attachment 10 to clean the vagina, and a different, preferably smaller, attachment 10 to clean the anus. A user may wish to vary attachments 10 based on the physical sensation provided by different ones. And, where a shower is used by more than one user, each may have their own preference with respect to particular features of a particular attachment 10. Finally, as part of such a set, it may be desired to include a shower attachment of a traditional, prior art type of style, so that privacy may be maintained and the shower configured for more traditional use by others. (Privacy may also be safeguarded by providing a case (not shown), which may be mounted on the shower wall and into which the attachment 10 may be placed when not in use.)

In one embodiment, as illustrated in FIGS. 2 and 4, the attachment 10 is threadably coupled to a first end of flexible hose 16. In this example, a threaded shaft 20 projects from a bottom end of the attachment 10, and threadably engages a mating receiver 22 coupled to the flexible hose 16. Turning more specifically to FIG. 4, in this embodiment, it can be seen that threaded shaft 20 has an opening 24 therethrough, which permits water to exit the flexible hose 16 and enter the attachment 10. Flange 26 surrounds the base of threaded shaft 20. From this end, it can be seen that the attachment 10 preferably includes an internal casing 28, which is preferably substantially rigid. The shaft 14 preferably further features a surface material 30, which is the material that would actually contact a user during use. The surface material 30 may be substantially rigid, such as a hard plastic or metal, or may be deformable, such as a gel or latex material.

It should be apparent that the attachment means shown in FIGS. 2 and 4 is exemplary only. There would be myriad other ways to couple the attachment 10 to the flexible hose 16. It may, for example, be desired to provide a quick connect coupling between these two elements.

Although not required, it should be noted that it would be preferable to select a material for the casing 28 and for the surface material 30 that is capable of transmitting the temperature of the water passing through the interior of the attachment 10. Some users may prefer a warm or hot sensation along the shaft 14, others may prefer a cold sensation, and materials that communicate water temperature may provide an enhanced physical sensation for the user.

As shown in FIGS. 1 and 2 particularly, it may be desired to mold the surface material 30 so as to provide a textured shape and feel for the shaft 14. Among other things, it may be desired to provide along the shaft 14 and/or on the glans 12 bumps, ridges, grooves, and/or spikes to provide different physical sensations for a user.

In one embodiment, as shown for example in FIG. 6, it may be desired to provide a soap dispenser 32, in communication with the attachment 10. The soap dispenser 32 could be configured to dispense soap onto the hand of a user, or, alternatively, could be configured to dispense soap into an interior of the attachment 10, where it can then mix with the water passing therethrough and emitted through openings in the attachment 10. Such a configuration could be utilized to provide a more effective cleaning action. In addition to soap, it should be clearly understood that other liquid-type agents could be dispensed from the soap dispenser 32, such as a lubricant.

In the embodiments described above, the attachment 10 has the shape of a male penis. It should be noted that it may be desired to configure the attachment 10 as another human structure, including for example a finger, tongue or a vagina.

Other features may also be utilized as desired. For example, it may be desired to utilize a surface material 30 that glows in the dark. It may be desired to provide a vibrating feature for the attachment 10, whether in the form of a pulsing water jet through the attachment 10 or through electrical vibrator means coupled to the attachment 10. It may further or alternatively be desired to provide means for allowing the shaft 14 and/or the glans 12 to rotate. It may be desired to permit a user to selectively turn the water spray on and off proximate the attachment 10, for example to simulate ejaculation.

It should be noted additionally that a while the use of a flexible hose 16 is preferred, it may be desired to couple the shower attachment 10 to a water source 18 that is located at a lower portion of the shower, so that a user may utilize the shower attachment 10 in one or more of the manners described herein by bringing the desired portion of the body of the user into contact with the fixed shower attachment 10.

While the invention has been particularly shown and described with reference to preferred embodiments thereof, it will be understood by those skilled in the art that the foregoing and other changes in form and details may be made therein without departing from the spirit and scope of the invention.

I claim:

1. A shower attachment comprising, in combination:
a shower attachment having the appearance of a human structure; and
means for coupling said shower attachment to a water source.

2. The shower attachment of claim 1 wherein said human structure is a penis having a shaft and a glans.

3. The shower attachment of claim 2 further comprising at least one opening in said glans.

4. The shower attachment of claim 2 further comprising a plurality of openings in said glans.

5. The shower attachment of claim 1 further comprising a flexible hose coupled at a first end thereof to said shower attachment and at a second end thereof to a water source.

6. The shower attachment of claim 2 wherein said shaft has a textured outer surface adapted to provide an enhanced physical sensation upon contact between said outer surface and a body of a user of said shower attachment.

7. The shower attachment of claim 2 wherein said shower attachment is comprised of materials permitting the transmission of water temperature from an interior of said shaft to an exterior of said shaft.

8. The shower attachment of claim 1 further comprising a soap dispenser coupled to said shower attachment.

9. A shower attachment comprising, in combination:
a shower attachment having the appearance of a human structure;
wherein said human structure is a penis having a shaft and a glans;
means for coupling the shower attachment to a water source;
at least one opening in said glans; and
a flexible hose coupled at a first end thereof to said shower attachment and at a second end thereof to a water source.

10. A method for providing an enhanced shower experience, comprising the steps of:
providing a shower attachment having the appearance of a human structure;
coupling the shower attachment to a water source;
transmitting water from said water source through said shower attachment;
bringing said shower attachment into contact with a body of a person using said shower attachment.

11. The method of claim 10 wherein said human structure is a penis having a shaft and a glans.

12. The method of claim 11 further comprising the step of providing at least one opening in said glans.

13. The shower attachment of claim 11 further comprising the step of providing a plurality of openings in said glans.

14. The method of claim 11 further comprising the step of providing at least one opening in said shaft.

15. The method of claim 10 further comprising the steps of:
providing a flexible hose; and
coupling said flexible hose at a first end thereof to said shower attachment and at a second end thereof to a water source.

16. The method of claim 11 wherein said shaft has a textured outer surface adapted to provide an enhanced physical sensation upon contact between said outer surface and a body of a user of said shower attachment.

17. The method of claim 11 wherein said shower attachment is comprised of materials permitting the transmission of water temperature from an interior of said shaft to an exterior of said shaft.

18. The method of claim 11 further comprising the step of providing means for causing said shaft to vibrate.

19. The method of claim 11 further comprising the step of providing means for said shaft to rotate.

20. The method of claim 11 further comprising the step of pulsing water through said shower attachment.
